(19) United States
(12) Patent Application Publication
(10) Pub. No.: US 2025/0281995 A1
(43) Pub. Date: Sep. 11, 2025

(54) Flash-Butt Welding Vehicle, Systems, and Methods of Using the Same

(71) Applicant: Holland, L.P., Crete, IL (US)

(72) Inventor: Joshua Horner, Naperville, IL (US)

(21) Appl. No.: 19/074,867

(22) Filed: Mar. 10, 2025

Related U.S. Application Data
(60) Provisional application No. 63/562,817, filed on Mar. 8, 2024.

(51) Int. Cl. B23K 11/04; B23K 101/26

(52) U.S. Cl. CPC B23K 11/046; B23K 2101/26

(57) ABSTRACT

A single flash-butt welding vehicle performs most if not all operations needed for flash-butt weld repair of a railroad track. Specifically, the flash-butt welding vehicle utilizes primary and secondary integral cranes for moving and manipulating rail and for welding the same. The vehicle further utilizes one or more rail storage areas thereon for loading, transporting, and unloading multiple sizes and lengths of rail. Systems and methods of using the same are further provided.

### CROSS-REFERENCE TO RELATED APPLICATIONS

The present invention claims priority to U.S. Provisional Pat. App. No. 63/562,817, titled “Flash-Butt Welding Vehicle, Systems, and Methods of Using the Same,” filed Mar. 8, 2024, which is incorporated herein by reference in its entirety.

### TECHNICAL FIELD

The present invention relates to a flash-butt welding vehicle that performs most if not all operations needed for flash-butt weld repair of a railroad track. Specifically, the flash-butt welding vehicle utilizes primary and secondary integral cranes for moving and manipulating rail and for welding the same. The vehicle further utilizes one or more rail storage areas thereon for loading, transporting, and unloading multiple sizes and lengths of rail. Systems and methods of using the same are further provided.

### BACKGROUND

Flash-butt welding is a type of resistance welding that welds two pieces of metal together and is ideal for use in repairing railroad tracks. Typically, the pieces of metal, i.e., the rail sections to be welded, are set apart at a predetermined distance based on material thickness, material composition, and desired properties of the finished weld. Current is applied to the metal, and the gap between the two pieces creates resistance and produces the arc required to melt the metal. Once the pieces of metal reach the proper temperature, they are pressed together, effectively forge-welding them together.

As noted, railroads use flash-butt welding to join sections of mainline rail together to create Long Welded Rail (LWR) in a factory setting or continuous welded rail (CWR) in track, which is much smoother than mechanically joined rail because there are no gaps between the sections of rail. Flash-butt welding is also beneficial because it allows dissimilar metals, including non-ferrous metals, to be joined. This allows switches and crossings, which are generally composed of high manganese steel, to be effectively welded to carbon steel rail with the use of a stainless steel insert, while keeping the desired mechanical properties of both the rails and the crossings intact.

In flash-butt welding, a damaged rail section is often cut and removed from a railroad track forming a gap on the track. An undamaged rail section of roughly the same length, known as a plug, is then placed precisely within the gap, and the terminal ends of the undamaged rail section are welded to the ends of the existing track that terminate at the gap.

To repair railroad tracks, it is common to send a crew of several workers and several vehicles to a site needing repair. For example, one truck may carry the rail for use in the repair, another truck may carry the cutting and/or welding equipment, and another may carry a crane for unloading plugs and placing them on site for rail repair. This may further require a crew of about eight or more workers. In another example, two trucks may be utilized, one carrying the rail and a crane for moving the rail and another for carrying the cutting and/or welding equipment, and a smaller crew of about 5 or 6 workers that can fit on the two trucks.

The use of multiple vehicles for loading, transporting, unloading, and welding rail to repair railroad track is inefficient, not cost effective, and environmentally damaging. Specifically, the use of multiple vehicles requires the use of a large number of crew, some just for piloting the vehicles. In addition, the vehicles require fuel and maintenance, which can be costly, and the workers require payment. The use of multiple vehicles further generates pollution and fosters environmental degradation.

A need, therefore, exists for an improved vehicle for repairing damaged railroad tracks. Specifically, a need exists for an improved vehicle having the capacity for loading, transporting, and unloading rail sections. Moreover, a need exists for an improved vehicle for further having cutting and/or welding equipment thereon for repairing the railroad tracks.

Further, a need exists for an improved vehicle for repairing damaged railroad tracks that uses a single vehicle for all operations of flash-butt welding of rail sections when repairing railroad tracks. Specifically, a need exists for an improved vehicle for repairing damaged railroad tracks that may maximize efficiency and cost effectiveness. Moreover, a need exists for an improved vehicle for repairing damaged railroad tracks that is cleaner for the environment than prior systems.

### SUMMARY OF THE INVENTION

The present invention relates to a flash-butt welding vehicle that performs most if not all operations needed for flash-butt weld repair of a railroad track. Specifically, the flash-butt welding vehicle utilizes primary and secondary integral cranes for moving and manipulating rail and for welding the same. The vehicle further utilizes one or more rail storage areas thereon for loading, transporting, and unloading multiple sizes and lengths of rail. Systems and methods of using the same are further provided.

To this end, in an embodiment of the present invention, a vehicle for use in flash-butt welding rail sections on a railroad track is provided. The vehicle comprises a bed having a first crane mounted thereon, wherein the first crane comprises welding equipment utilized for flash-butt welding, a second crane for deploying rail sections from the vehicle, and at least one storage area for holding, storing, and transporting rail sections.

It is, therefore, an advantage and objective of the present invention to provide an improved vehicle for repairing damaged railroad tracks.

Specifically, it is an advantage and objective of the present invention to provide an improved vehicle having the capacity for loading, transporting, and unloading rail sections.

Moreover, it is an advantage and objective of the present invention to provide an improved vehicle for further having cutting and/or welding equipment thereon for repairing the railroad tracks.

Further, it is an advantage and objective of the present invention to provide for the repair of damaged railroad tracks that uses a single vehicle for all operations of flash-butt welding of rail sections when repairing railroad tracks.

Specifically, it is an advantage and objective of the present invention to provide an improved vehicle for repairing damaged railroad tracks that may maximize efficiency and cost effectiveness.

Moreover, it is an advantage and objective of the present invention to provide an improved vehicle for repairing damaged railroad tracks that is cleaner for the environment than prior systems.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A and 1B illustrate a opposite perspective views of a flash-butt welding vehicle in an embodiment of the present invention.

FIG. 2 illustrates a top view of a flash-butt welding vehicle in an embodiment of the present invention.

### DETAILED DESCRIPTION OF THE PRESENTLY PREFERRED EMBODIMENTS

The present invention relates to a flash-butt welding vehicle that performs most if not all operations needed for flash-butt weld repair of a railroad track. Specifically, the flash-butt welding vehicle utilizes primary and secondary integral cranes for moving and manipulating rail and for welding the same. The vehicle further utilizes one or more rail storage areas thereon for loading, transporting, and unloading multiple sizes and lengths of rail. Systems and methods of using the same are further provided.

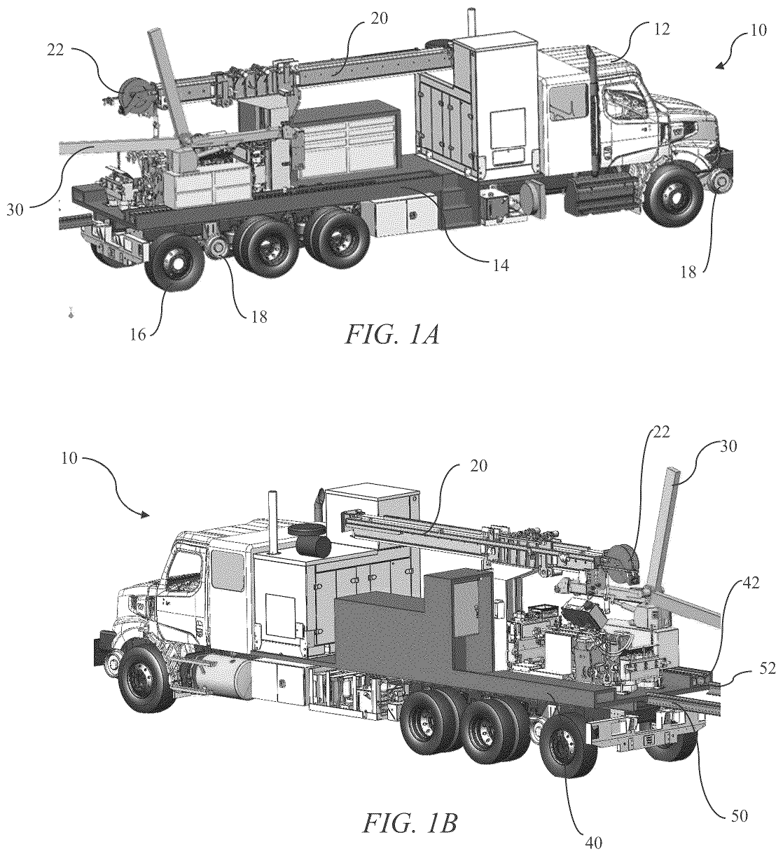

FIGS. 1A and 1B illustrate opposite views of a flash-butt welding vehicle 10 in an embodiment of the present invention. Specifically, the flash-butt welding vehicle 10 generally comprises a cab 12, a bed 14, a plurality of wheels 16 for moving the truck on a roadway, and a plurality of rail wheels 18 for moving the vehicle 10 along a railroad track. As such, the vehicle may operate on both roadways and railroad tracks, known in the industry as a dual mode hi-rail truck.

Disposed on the bed 14 may be a number of elements that may be useful for repairing railroad tracks. Specifically, the bed 14 may hold a first crane 20 having welding equipment 22 thereon, which may be utilized to extend and deploy from the bed 14 and be placed in any adjacent location to weld rail sections together via flash-butt welding.

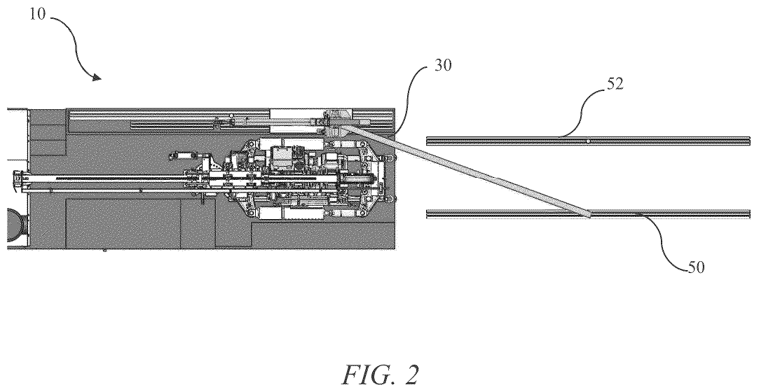

Further disposed on the bed 14 may be a second crane 30 which may be utilized for loading, unloading, and placing rail sections from the vehicle 10, as described in more detail below. The second crane 30 may extend at or near the rear of the bed 14 and may be utilized for loading the rail sections on to the bed 14, such as at a depot or the like prior to deploying the vehicle 10 to a location for repairing railroad tracks. Moreover, the second crane 30 may remove rail sections from the bed 14 and may further place the rail sections on either side of the vehicle 10, behind the vehicle 10, and at many different angles relative to the vehicle 10. Thus, once a damaged rail section is removed from a railroad track, the second crane 30 may be utilized for unloading a rail section, deploying the rail section for cutting of the same, and for precisely placing the fitted rail section into a gap left when the damaged rail section is removed. FIG. 2 illustrates the second crane 30 deployed to precisely place a rail section behind the vehicle 10.

Additionally, the bed 14 may further have one or more storage areas 40, 42 for storing various lengths of rail for use in flash-butt welding. Preferably, the one or more storage areas 40, 42 may be disposed beneath the first crane 20 and/or the second crane 30 and may allow various lengths of rail to be stored and transported therein. The storage areas 40, 42 may be accessible from the rear of the bed 14 so that a rail section may be easily grabbed and pulled therefrom using the second crane 30. The storage areas 40, 42 may run the length of the bed 14, thereby allowing lengthy rail sections 50, 52 to be loaded, stored, transported, unloaded, and used during a rail repair process. For example, rail sections having lengths of up to about 19′ 6″ may be loaded, stored, transported, unloaded, and used using the vehicle 10 of the present invention. Of course, any length of rail may be placed thereon and deployed therefrom and the present invention should not be limited as described herein.

The vehicle 10 may have a plurality of other elements that may be useful for repairing railroad tracks via flash-butt welding. For example, controls and machinery for manipulating the first crane 20 and/or second crane 30 may be located thereon. Moreover, various toolboxes and storage boxes may be mounted thereon, as well as any number of tools may be stored therein as may be necessary to repair a railroad track. In addition, a cutting saw or other cutting mechanism may be present on the bed 14, such as a saw for cutting rail sections to precise lengths. For example, the saw may be removable for placing on damaged rail to cut therethrough and/or for cutting rail sections to precise lengths for flash-butt welding of the same.

Because the vehicle 10 is a dual mode hi-rail vehicle, it may be transported to a damaged rail either through a roadway system, on the railroad tracks, or both, allowing the vehicle to have access to any damaged railroad track section necessary. Moreover, the vehicle 10 may further be placed on the tracks via the rail wheels 18 for deployment of the welding equipment 22 on the first crane 20 and/or for deployment of the rail sections using the second crane 30 behind the vehicle 10. Alternatively, the vehicle may be driven next or adjacent the railroad tracks via the road wheels 16 for deployment of the welding equipment 22 and/or for deployment of the rail sections beside the vehicle 10.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

What is claimed is:

1. A vehicle for use in flash-butt welding rail sections on a railroad track comprising:
a bed having a first crane arm mounted thereon, wherein the first crane arm comprises welding equipment utilized for flash-butt welding;
a second crane arm for deploying rail sections from the vehicle; and
a first storage area for holding, storing, and transporting one or more railroad track rail sections.

2. The vehicle of claim 1 further comprising:
a plurality of wheels for driving the vehicle on a roadway; and
a plurality of train wheels for driving the vehicle on a railroad track.

3. The vehicle of claim 1 wherein the first crane arm is configured to extend and deploy from the vehicle.

4. The vehicle of claim 1 wherein the second crane arm is configured to extend and deploy from the vehicle.

5. The vehicle of claim 1 wherein the second crane arm is configured to load, unload, and place rail sections from the vehicle.

6. The vehicle of claim 1 wherein the second crane arm extends from a location at or near a rear of the bed.

7. The vehicle of claim 1 wherein the storage area is disposed beneath the first crane arm or the second crane arm.

8. The vehicle of claim 1 wherein the first storage area has an opening for loading and unloading the railroad track rail sections.

9. The vehicle of claim 8 wherein the opening is disposed at or near a rear of the bed.

10. The vehicle of claim 1 further comprising:
a second storage area within the bed.

11. The vehicle of claim 1 wherein the first storage area and the second storage area are disposed at or near the rear of the bed.

12. The vehicle of claim 1 wherein the first storage area and the second storage area are disposed on opposite sides of the bed.
